(19) United States
(12) Patent Application Publication
(10) Pub. No.: US 2007/0006714 A1
(43) Pub. Date: Jan. 11, 2007

(54) Outlet cover for a wind instrument

(76) Inventor: Wen-Hung Kuo, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,846

(22) Filed: Jul. 5, 2005

(51) Int. Cl. G10D 9/04

(52) U.S. Cl. 84/385 P

(57) ABSTRACT

An outlet cover has a felt pad, a paper pad, a coat, an echo cap and a fastener. The paper pad is attached to the felt pad. The coat is mounted on and encloses the felt pad and the paper pad. The echo cap is attached to an outside of the coat and is made of porcelain clay. The fastener extends through the felt pad, the paper pad, the coat and the echo cap to securely combine the pads, the echo cap and the coat together. The porcelain echo cap does not become oxidized and has a smooth surface to improve the timbre of the sound issued from the wind instrument.

### BACKGROUND OF THE INVENTION

1. Field of the Invention

The present invention relates to an outlet cover, and more particularly to an outlet cover for a wind instrument and having an echo cap made of porcelain clay.

2. Description of Related Art

Wind instruments, such as trumpets, trombones, French horns, clarinets or saxophones have multiple air outlets defined in a body of the instrument. When one or several outlets are closed, the resonance of the instrument is different so that different tone can be played. To close the outlets in the instrument, with reference to FIGS. 4 and 5, multiple outlet covers (40) are mounted respectively on multiple keys (20) that are pivotally mounted on the instrument and correspond respectively to the outlets (22). When a user presses the keys (20), the outlet covers (40) will close the corresponding outlets (22) to make the instrument play different tones.

With reference to FIGS. 5 and 6, a conventional outlet cover (40) in accordance with the prior art comprises a felt pad (42), a paper pad (43), a coat (44), an echo pad (46) and a fastener (48). The paper pad (43) is attached to one side of the felt pad (42). The coat (44) is mounted on and encloses the felt pad (42) and the paper pad (43). The echo pad (46) is attached to an outside of the coat (44) and corresponds to a corresponding outlet (22). The fastener (48) extends through the felt pad (42), the paper pad (43), the coat (44) and the echo pad (46) to securely combine the pads (42,43,46) and coat (44) together. When the keys (20) are pressed, the echo pads (46) on the outlet covers (40) will enter into the corresponding outlets (22) to provide a guiding effect and a resonance effect to the airflow in the instrument.

The conventional echo pad (46) is commonly made of metal or plastic material. However, the conventional metal echo pad (46) easily becomes oxidized after a time of use, and the oxidized echo pad (46) provides an inferior guiding and resonance effect. In addition, the oxidized echo pad (46) easily damages the coat (44), and the useful life of the outlet cover is shortened.

Furthermore, the plastic material is soft, so the sound generating through a conventional plastic echo pad (46) is not as good as desired.

To overcome the shortcomings, the present invention tends to provide an outlet cover for wind instruments to mitigate or obviate the aforementioned problems.

### SUMMARY OF THE INVENTION

The main objective of the invention is to provide an outlet cover for a wind instrument and one that can improve the timbre of the sound issued from the wind instrument. The outlet cover has a felt pad, a paper pad, a coat, an echo and a fastener. The paper pad is attached to the felt pad. The coat is mounted on and encloses the felt pad and the paper pad. The echo cap is attached outside the coat and is made of porcelain clay. The fastener extends through the felt pad, the paper pad, the coat and the echo cap to securely combine the pads, the echo cap and the coat together.

Other objects, advantages and novel features of the invention will become more apparent from the following detailed description when taken in conjunction with the accompanying drawings.

### BRIEF DESCRIPTION OF THE DRAWINGS

FIG. 1 is a partial perspective view of a wind instrument with an outlet cover in accordance with the present invention;

FIG. 2 is an exploded perspective view of the outlet cover in FIG. 1;

FIG. 3 is a side plan view in partial cross section of an outlet covered with the outer cover in FIG. 2;

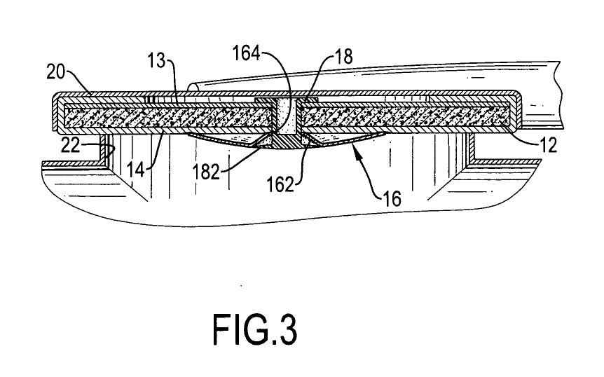

FIG. 4 is a perspective view of a conventional saxophone;

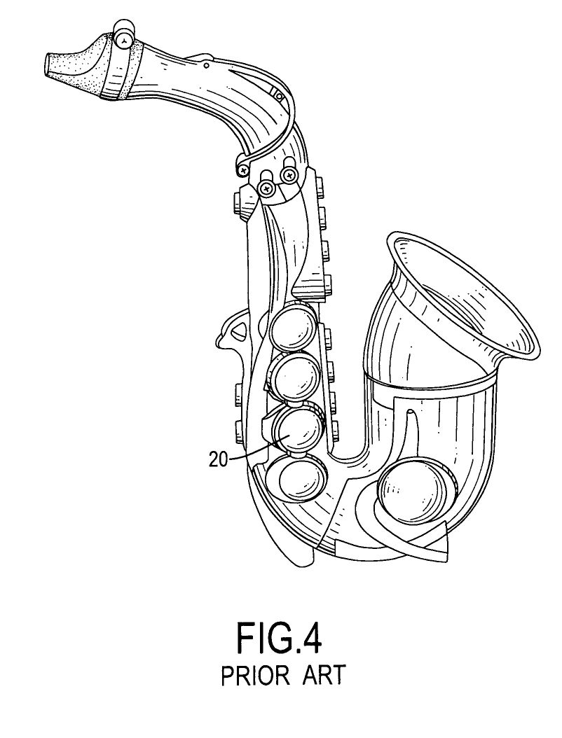

FIG. 5 is a perspective view in partial cross section of a wind instrument with a conventional outlet cover in accordance with the prior art; and

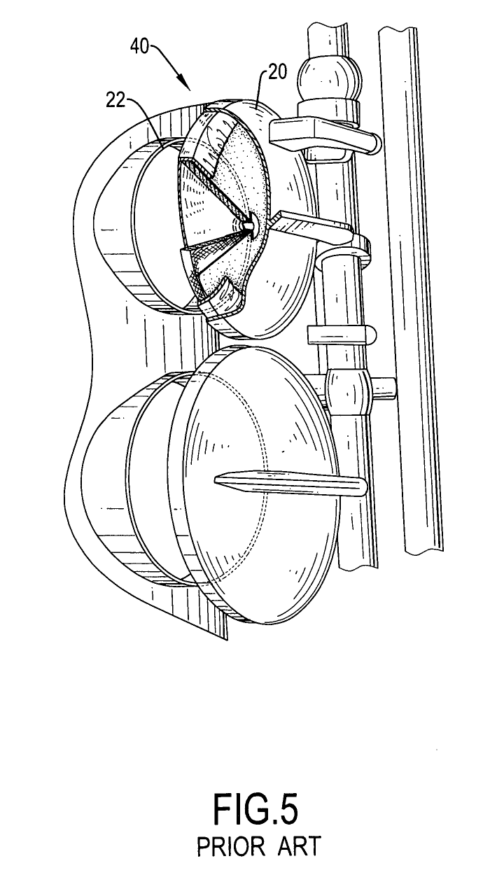

FIG. 6 is a side plan view in partial cross section of an outlet covered with the conventional outer cover in FIG. 5.

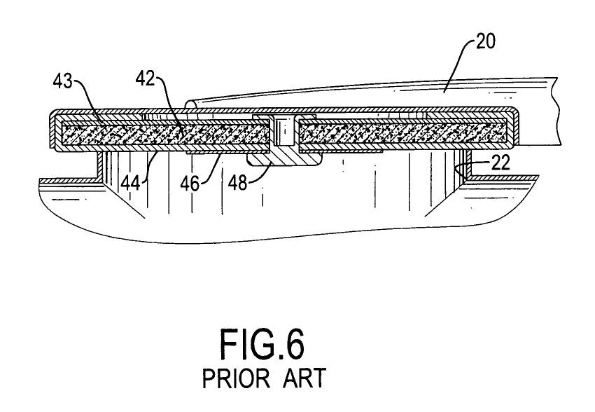

### DETAILED DESCRIPTION OF PREFERRED EMBODIMENT

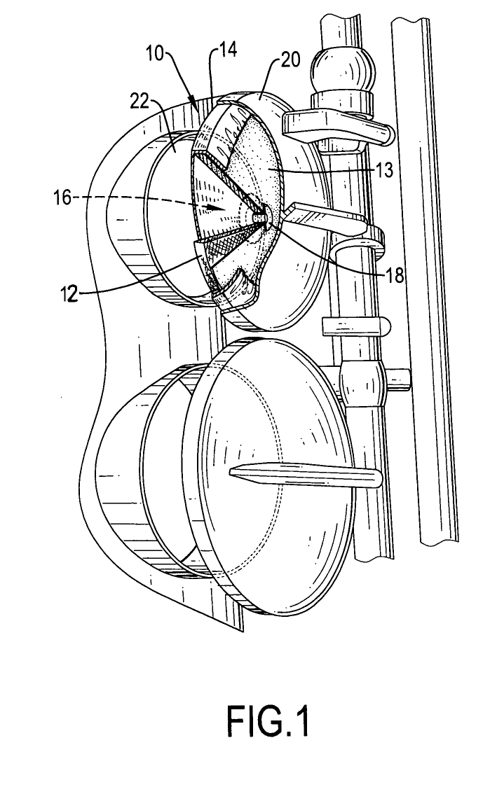

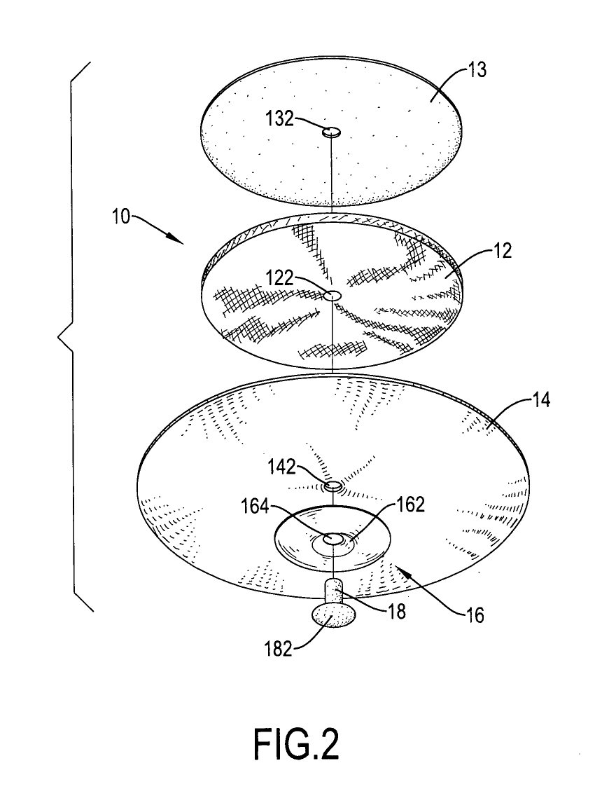

With reference to FIGS. 1 and 2, an outlet cover (10) for a wind instrument in accordance with the present invention is securely mounted on a key (20) of the instrument and comprises a felt pad (12), a paper pad (13), a coat (14), an echo cap (16) and a fastener (18). The felt pad (12) is formed as a disc, is made of wool and a through hole (122) is defined through the felt pad (12). The paper pad (13) is a round pad, is attached to one side of the felt pad (12) and has a through hole (132) aligning with the through hole (122) in the felt pad (12). The coat (14) is made of natural leather and is mounted on and encloses the felt pad (12) and the paper pad (13). The coat (14) has a through hole (142) aligning with the through holes (122,132) in the felt and paper pads (12,13). The echo cap (16) is attached to an outside of the coat (14) and is made of porcelain clay. The echo cap (16) corresponds to an outlet (22) in the wind instrument. In a preferred embodiment, the echo cap (16) has an arcuate surface and a cavity (162) with a bottom defined in the center of the echo cap (16). A through hole (164) is defined through the echo cap (16) and in the bottom of the cavity (162) and aligns with the through holes (122,132,142) in the felt pad (12), the paper pad (13) and the coat (14). The fastener (18) extends through the through holes (122,132,142,162) in the felt pad (12), the paper pad (13), the coat (14) and the echo cap (16) to securely combine the pads (12,13), the echo cap (16) and the coat (14) together. The fastener (18) has a shank extending through the through holes (122,132,142,162) in the pads (12,13), the coat (14) and the echo cap (16) and a semispherical head (182) held inside the cavity (162) in the echo cap (16).

The characteristics of porcelain clay are such that the echo cap (16) has enough hardness to make the sound played by the instrument with the echo caps (16) acute for playing specific music and is versatile in use.

The porcelain echo cap (16) has a smooth inner surface and does not become oxidized, so the airflow in the instrument is always smooth and the timbre of sound issued from the instrument is improved. In addition, with the arcuate surface on the echo cap (16) and the semispherical head (182) of the fastener (18), an excellent guiding effect to airflow is provided so as to further improve the timbre of sound issued from the instrument.

The porcelain echo cap (16) in accordance with the present invention does not oxidize, nor does it deform after a long time of use, so that the useful life of the outlet cover (10) is prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An outlet cover for a wind instrument comprising:
a felt pad;
a paper pad attached to the felt pad;
a coat mounted on and enclosing the felt pad and the paper pad;
an echo cap attached to an outside of the coat; and
a fastener extending through the felt pad, the paper pad, the coat and the echo cap to securely combine the pads, the echo cap and the coat together,
wherein the echo cap is made of porcelain clay.

2. The outlet cover as claimed in claim 1, wherein the echo cap has an arcuate surface.

3. The outlet cover as claimed in claim 2, wherein the echo cap has a center, a cavity with a bottom defined in the center and a through hole defined through the echo cap and in the bottom of the cavity; and
the fastener has
a shank extending into the through hole in the echo cap and through the felt pad, the paper pad, the coat and the echo cap; and
a semispherical head held inside the cavity in the echo cap.
